(19) United States
(12) Patent Application Publication
(10) Pub. No.: US 2009/0210086 A1
(43) Pub. Date: Aug. 20, 2009

(54) SYSTEMS AND METHODS FOR SORTING IRREGULAR OBJECTS

(75) Inventors: Uzi LevAmi, Hod Hasharon (IL); Svante Bjarne Wold, Campton, NH (US)

Correspondence Address: PROSKAUER ROSE LLP, ONE INTERNATIONAL PLACE, BOSTON, MA, 02110, US

(73) Assignee: MKS instruments, Inc., Andover, MA (US)

(21) Appl. No.: 12/337,310

(22) Filed: Dec. 17, 2008

Related U.S. Application Data
(60) Provisional application No. 61/015,453, filed on Dec. 20, 2007.

(51) Int. Cl. B07C 5/34

(52) U.S. Cl. 700/223

(57) ABSTRACT

A system and method is provided for computerized sorting irregular objects. The method includes receiving a representative set of irregular objects comprising at least two types of user-specified qualities. The method also includes receiving at least two types of measured data for the representative set of irregular objects. The method also includes generating at least one of a PCA model or a PLS model based on at least two user-specified qualities of the irregular objects and the at least two types of measured data for the representative set of irregular objects, and sorting a second set of irregular objects based on the at least one of the PCA model or the PLS model.

### RELATED APPLICATIONS

This application relates to and claims the benefit and priority of provisional application entitled “Sorting Irregular Objects,” U.S. Patent Application No. 61/015,453, filed on Dec. 20, 2007, the disclosure of which is hereby incorporated herein by reference in its entirety.

### FIELD OF THE INVENTION

The present invention relates generally to computer-based methods and apparatuses, including computer program products, for sorting irregular objects.

### BACKGROUND

Qualitative discrimination methods for irregular objects have been the focus of automation for many years. For example, while a box usually has six flat surfaces and twelve edges that can be easily measured to determine the length, width, height, and other characteristics of the box, the human face has an irregular (i.e., spacially complicated) surface which can not be easily defined and/or measured. The two main qualitative sorting methods businesses utilize to characterize irregular objects are human sorting and automated sorting. Traditionally sorting was done by employees who could make qualitative judgments about the irregular objects, such as shape, size, color, scent, and other pertinent qualities. For example, jewelers view each diamond to determine its appraisal value based on numerous characteristics such as carat weight, diamond density, diamond color, diamond cut, and fluorescence. Then, based on a combination of these features, the jeweler can determine the appropriate sales price for the diamond.

Limitations on human sorting include scalability and cost-effectiveness. Some irregular objects, such as diamonds, are extremely valuable and have a formidable profit margin, so individual evaluation is worthwhile. However, other irregular objects, particularly naturally grown items, are not as profitable and consequently do not facilitate individual sorting. For example, a flower dealer must sort flowers before selling them to the flower shop in a way to achieve a maximum profit, but it is not cost-effective for each flower to be sorted by hand. If each flower yields an average profit of twenty to thirty cents, a farmer can not afford to spend ten cents to evaluate each individual flower. Furthermore, problems with consistent sorting among multiple human sorters arise since classes are difficult to define because humans sort based on a comparison of high and low quality.

Automated sorting methods attempt to mathematically define subjective qualities of the irregular objects and classify new objects based on the existing classes. One automated sorting method is parameter-based sorting, which measures features and assigns regions for each class. Parameter based sorting, however, is limited to the number of features used for the irregular objects. Discriminant analysis (DA) is another option and facilitates the use of multiple features with each class. DA adequately groups features, but difficulties arise when there are internal dependencies between the classes.

While automated sorting methods are more scalable and cost-effective than human sorting, there are inherent difficulties with attempting to mathematically translate a subjective judgment decision and relate it to objective features of the irregular objects. Modeling the difference between a high quality irregular object and a low quality irregular object is nontrivial. This is particularly difficult for irregular objects since the qualities are more difficult to define and will include additional variation between the classes. Although automated sorting methods can be used to certain degrees of success, it is often desirable to combine multiple features to analyze a particular irregular object and sort the objects based on a combination of the features. For example, roses are often classified based on stem length. However, by classifying only stem length, the farmer has no control over other features such as leave shape, scent, and petal structure. Traditional sorting method approaches set up rules and design the system based on machine measurements and calculations. Consequently, there are too many criteria for a single sorting machine to sort based on all the various features. The difficulty of subjective characterization of irregular objects has been the main obstacle to using certain features in automated sorting methods.

### SUMMARY OF THE INVENTION

Much work has been done to enhance automated sorting methods for irregular objects. Accordingly, what is needed is a technique for providing a representative set of irregular objects with qualities of one or more classes of the irregular objects and to sort irregular objects based on a combination of the qualities.

A computerized method is provided for sorting irregular objects. The method includes receiving a representative set of irregular objects comprising at least two types of user-specified qualities. The method also includes receiving at least two types of measured data for the representative set of irregular objects. The method also includes generating at least one of a PCA model or a PLS model based on the at least two user-specified qualities of the irregular objects and the at least two types of measured data for the representative set of irregular objects, and sorting a second set of irregular objects based on the at least one of the PCA model or the PLS model.

The representative set of the irregular objects can include a class of the irregular objects. In one embodiment, generating at least one of a PCA model or a PLS model includes generating at least one PCA model and at least one PLS model based on the at least two user-specified qualities of the irregular objects and the at least two types of measured data for the representative set of irregular objects. In one embodiment, the second set of irregular objects are sorted based on the at least one PCA model and the at least one PLS model.

In one embodiment, sorting includes calculating membership of the irregular objects within a class, and sorting the second set of irregular objects within the class. In one embodiment, T2 and DModX are calculated for the PCA model, and a class of the irregular objects is selected based on T2 and DModX.

In one embodiment, the second set of irregular objects are sorted within a class. Sorting the second set of irregular objects can include computing a grade of the second set of irregular objects and the irregular objects can be sorted based on the grade. The grade of the irregular objects can be computed based on a user input. Sorting the second set of irregular objects can include parameter sorting. A maximum profit group of the second set of irregular objects can be calculated.

In one embodiment, the at least two user-specified qualities of the irregular objects are adjusted based on a user-specified qualitative perception of the irregular objects. The irregular objects can include plants, flowers, insects, vegetables, fruits, leaves, trees, or any combination thereof. The at least two user-specified qualities can include length, shape, size, weight, color, thickness, scent, or any combination thereof.

In one embodiment, the at least two user-specified qualities are based on a particular feature of the irregular objects. A PCA model can be generated by specifying the at least two user-specified qualities for a specimen of a class and building a model for the class. The specimen can be previously sorted.

In one embodiment, a PLS model is generated by specifying the at least two user-specified qualities for a specimen of a class, grading the class, and building a model for the class.

A system is provided for sorting irregular objects. The system includes a learning module configured to generate at least one of a PCA model or a PLS model based on at least two user-specified qualities of the irregular objects received for a representative set of the irregular objects and at least two types of measured data for the representative set of the irregular objects, and a sorting module configured to sort a second set of irregular objects based on the at least one of the PCA model or the PLS model. In one embodiment, the learning module is further configured to generate at least one PCA model and at least one PLS model based on the at least two user-specified qualities of the irregular objects and the at least two types of measured data for the representative set of irregular objects.

In one embodiment, the sorting module is further configured to sort the second set of irregular objects based on the at least one PCA model and the at least one PLS model. The learning module can be configured to generate a PCA model based on a user specifying the at least two user-specified qualities for a specimen of a class and can build a model for the class.

In one embodiment, the learning module is further configured to generate a PLS model based on measuring the at least two user specified qualities for a specimen of a class, grading the class, and building a model for the class. The system can include a sensing module configured to sense one or more characteristics of the representative set of irregular objects. The system can further include a storage module configured to store the at least one of a PCA model or a PLS model.

The invention, in one aspect, relates to a computer program product for sorting irregular objects, tangibly embodied in an information carrier, the computer program product including instructions being operable to cause a data processing apparatus to receive a representative set of irregular objects comprising at least two types of user-specified qualities. The instructions are also operable to cause the data processing apparatus to receive at least two types of measured data for the representative set of irregular objects. The instructions are also operable to cause the data processing apparatus to generate at least one of a PCA model or a PLS model based on the at least two user-specified qualities of the representative set of irregular objects and the at least two types of measured data for the representative set of irregular objects, and sort a second set of irregular objects based on the at least one of the PCA model or the PLS model.

The invention, in one aspect, relates to a computerized method for sorting irregular objects. The method includes receiving a representative set of irregular objects comprising at least two types of user-specified qualities. The method also includes receiving at least two types of measured data for the representative set of irregular objects. The method also includes means for generating at least one of a PCA model or a PLS model based on the at least two user-specified qualities of the irregular objects and the at least two types of measured data for the representative set of irregular object, and means for sorting the second set of irregular objects based on the at least one of the PCA model or the PLS model.

The methods and systems provide the advantages of sorting irregular objects based on user-specified quality and a combination of many parameters of the irregular objects. A representative set, or training set, of data allows the system to learn. Experience and knowledge is used to get representative sets of objects and intelligent and relevant measurements. The systems and methods sort out typical patterns for each class, boundaries between the classes, and diagnose the success on future irregular objects. Advantageously, user identified subjective criteria can be modeled for un-measurable characteristics by associating objective (i.e., measurable) criteria of the irregular objects with the subjective criteria. Sorting systems can be trained to model human subjective decisions and to grade items based on the trained models. Grading allows the system to handle all irregular objects, even if the irregular object is a member of a class that is not defined for the model.

Some objectives of the invention are to (a) translate qualitative properties (i.e., user-specified qualities) of human impression into numerical classifications, (b) sort irregular objects based on the qualitative properties, and (c) allow the sorting method and system to adapt the numerical classification based on user input. Creating such numerical classifications allows the sorting of irregular objects based on human impression (i.e., user-specified qualities) without the additional overhead, resulting in a scalable, cost-effective, and less time intensive sorting system and method that is also user trainable. This will in turn provide sorting based on user-input examples and preferences to maximize profit.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A shows a sorting process for sorting irregular objects;

FIG. 1B shows exemplary result of sorted irregular objects using the sorting process of FIG. 1A;

FIG. 2 shows the sorting system of FIG. 1A for sorting irregular objects;

FIG. 3 shows the learning module of FIG. 2 for generating models of irregular objects;

FIG. 4A shows the PCA module from FIG. 3 for performing PCA analysis on the irregular objects;

FIG. 4B shows a PCA sorting process for sorting irregular objects using PCA;

FIG. 5A shows the PLS module from FIG. 3 for performing PLS analysis on the irregular objects;

FIG. 5B shows a PLS sorting process for sorting irregular objects using PLS; and

FIG. 6 shows a learning process for learning quality sorting criteria for irregular objects.

### DETAILED DESCRIPTION

Generally, a system sorts irregular objects based on multiple user-specified qualities of the irregular objects as follows. A user creates one or more groups of pre-sorted irregular objects. Machine measurement techniques are used to acquire data for features (i.e., measured data) of each irregular object. Additional raw data can be used as additional input for each irregular object. The data are used to build models of the irregular objects which represent user-specified qualitative properties of the irregular objects. A subsequent irregular object is measured using the same measurement techniques. Additional measurement techniques can also be used to provide additional data. The data are used to classify the subsequent irregular object into one or more user-specified qualitative classes using the models. The sorting system can be trained by varying the pre-sorted irregular objects and/or adjusting the models.

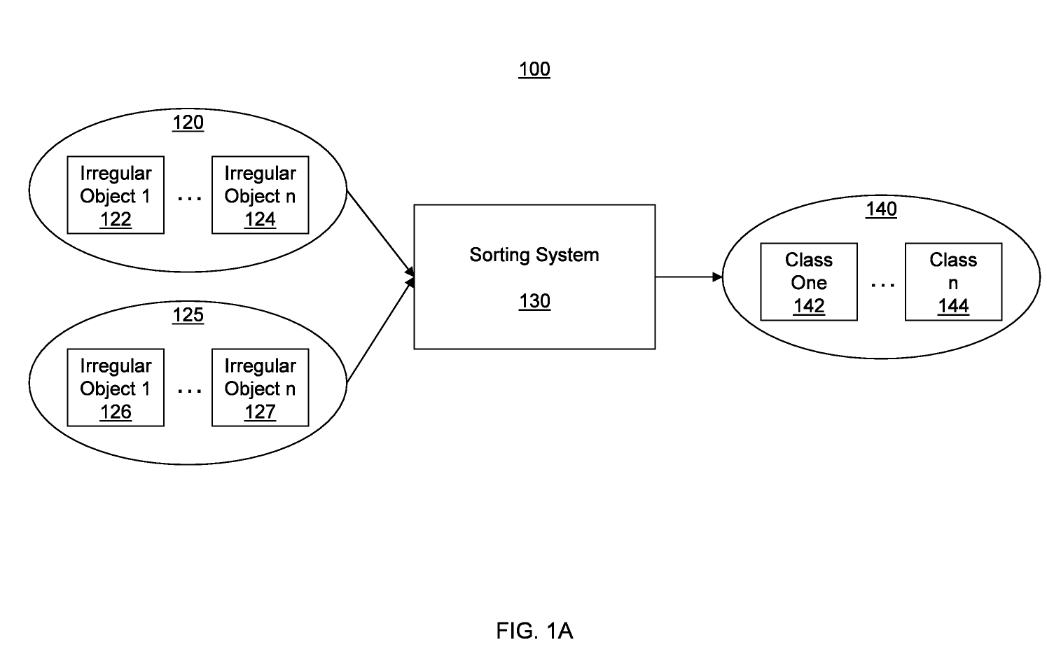

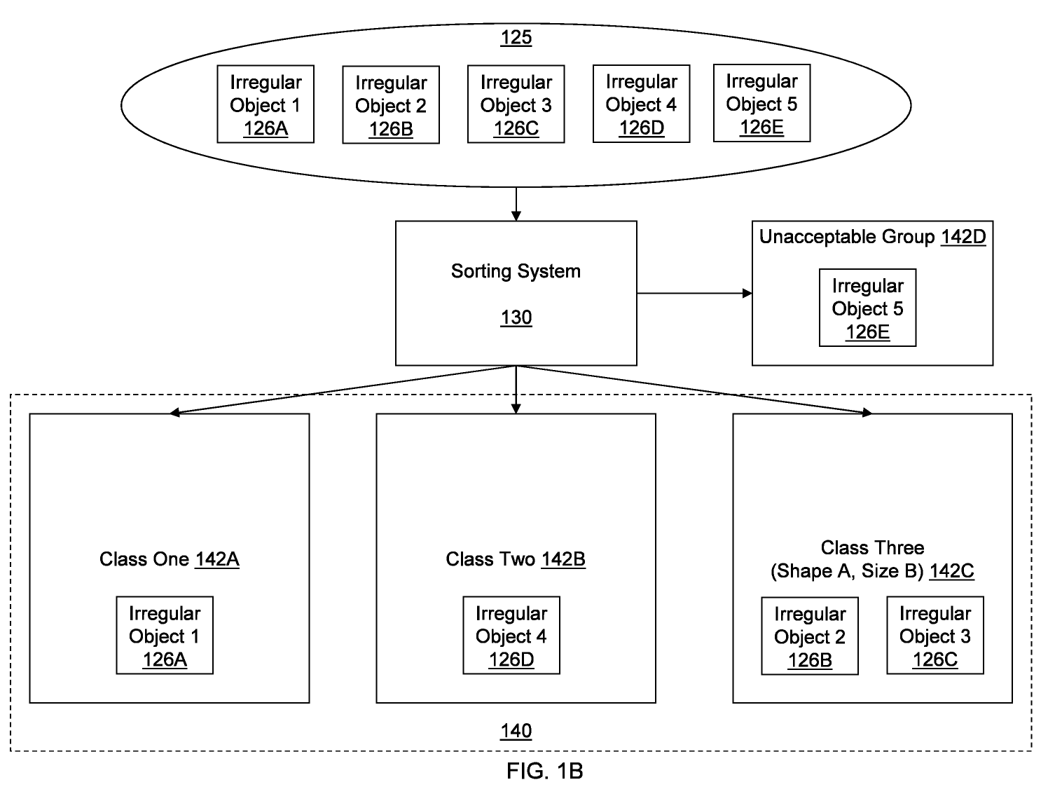

FIGS. 1A and 1B shows a sorting process system 100 for sorting irregular objects. The sorting process system 100 includes a training group of irregular objects 120, a sorting group of irregular objects 125, a sorting system 130, and a group of classes 140. The training group of irregular objects 120 is a representative set of irregular objects for user-specified qualities. The training group of irregular objects 120 includes irregular object one 122 through irregular object n 124. The sorting group of irregular objects 125 is an unclassified second group of irregular objects. The sorting group of irregular objects 125 includes irregular object one 126 through irregular object n 127. The irregular objects can be, for example, plants, flowers, vegetables, fruits, leaves, trees, insects, or any other object with difficult qualities to define. The group of classes 140 includes class one 142 through class n 144.

In some examples, the training group of irregular objects 120 comprises multiple groups, where each group belongs to a different class (e.g., a representative set of irregular objects for the user-specified quality “small,” a representative set of irregular objects for the user-specified quality “medium,” etc.). Each class can have an associated model (e.g., a PCA model, a PLS model, or both). The training group of irregular objects 120 can be used to calculate membership of the irregular objects within the sorting group of irregular objects 125 within one or more classes (e.g., class one 142 through class n 144). The irregular objects that are members of a particular class can be sorted within the class (e.g., based on an additional user-specified quality). In some examples, a perceived user-specified quality is submitted to the sorting system 130. The perceived quality can be used to grade the irregular objects within the sorting group of irregular objects 125. The sorting system 130 can learn from the training group of irregular objects 120. For example, the sorting system 130 can sort out typical patterns for each class (e.g., class one 142 through class n 144) based on the one or more classes made up by the training group of irregular objects 120. The sorting system 130 can determine boundaries between the classes based on the parameters derived from the data (i.e., measured data from the training group of irregular objects 120). The sorting system 130 can include feedback on how well irregular objects (e.g., irregular object one 126 through irregular object n 127 of the sorting group of irregular objects 125) are classified.

The training group of irregular objects 120 are fed into the sorting system 130. The training group of irregular objects 120 can be fed into the system, for example, by hand or with a conveyor belt. The training group of irregular objects 120 can be fed into the sorting system 130 individually. The sorting system 130 uses the training group of irregular objects 120 to generate one or more models of the irregular objects. The one or more models of the irregular objects are at least one of a PCA model, at least one of a PLS model, or a combination of one or more PCA models and one or more PLS models, which are generated based on the user-specified qualities of the irregular objects and measured data. For example, the Y values of the one or more models are the user-specified qualities of the irregular objects from the training group of irregular objects 120, and the X values of the one or more models are the measured data from the irregular objects from the training group of irregular objects 120. The training group of irregular objects 120 can allow the sorting system 130 to learn one or more classes (e.g. class one 142 through class n 144) of the irregular objects. The training group of irregular objects 120 can be used with, for example, prior experience and knowledge of the irregular objects.

For example, a user can define a qualitative sorting model with many different parameters (i.e., measured data) to mimic a subjective decision made by a human evaluator. A user can, for example, attempt to model many qualitative properties of the irregular objects, but only particular features (i.e., measured data) of the object will be relevant depending on the qualitative properties. For example, if a user is modeling the user-specified quality of “flower shape,” then electrical properties of the flower are irrelevant for generating the model. The sorting group of irregular objects 125 are fed into the sorting system 130. The sorting system 130 sorts or grades the sorting group of irregular objects 125 into a class (e.g. class 142 or class 144) using the one or more models of irregular objects. Grading finds a best match for each irregular object of the sorting group of irregular objects 125 to a class, even if the irregular object would not have been sorted into a class.

FIG. 1B shows an exemplary result of sorted irregular objects using the sorting process 100 of FIG. 1A. The sorting group of irregular objects 125 includes irregular object one 126A, irregular object two 126B, irregular object three 126C, irregular object four 126D, and irregular object five 126E (the irregular objects 126). The group of classes 140 includes class one 142A, class two 142B, and class three 142C. The unacceptable group 142D includes objects with features which do not meet any of the classes (e.g. class one 142A through class three 142C). The irregular objects are fed into the sorting system 130. The sorting system 130 determines the proper class to sort each irregular object into based on the features of the irregular object. The features are measured data for the irregular object. The sorting system 130 sorts irregular object one 126A into class one 142A. The sorting system 130 sorts irregular object four 126D into class two 142B. The sorting system sorts irregular object two 126B and irregular object three 126C into class three 146C. The sorting system 130 sorts irregular object five 126E into the unacceptable group 142D because it does not fit any acceptable class in the group of classes 140. The sorting system 130 rejects irregular object five 126E because it does not fit any acceptable class.

For example, the irregular objects can be flowers. The sorting system 130 can be configured to sort the flowers based on flower shape and flower size, which are the user-specified qualities of the irregular objects. A model can be generated for the sorting system 130 to sort the flowers. The model includes at least one of a PCA model, a PLS model, or a combination of one or more PCA models and one or more PLS models. Class one 142A can represent flowers with shape A and size A, class two 142B can represent flowers with shape B and size B, and class three 142C can represent flowers with shape A and size B. The sorting machine 130 sorts irregular object one 126A (e.g. a flower) into class one 142A because it has shape A and size A. The sorting machine sorts the irregular objects 126 by using the one or more models to sort the irregular objects into user-specified qualities based on measured data for the irregular objects. The sorting machine 130 sorts irregular object two 126B and irregular object three 126C into class three 142C because irregular object two 126B and irregular object three 126C have shape A and size B. The sorting machine 130 sorts irregular object four 126D into class two 142B because irregular object four 126D has shape A and size B. The sorting machine rejects object five 126D into the unacceptable group 142D because it has shape B and size A and doesn't fit any class in the group of classes 140. Any number of features (i.e., measurable data) can be used to sort the irregular objects. The irregular objects can be classified into multiple types of user-specified qualities (e.g., in addition to size and shape, the sorting system 130 can generate a model to sort the flowers based on color, scent, and weight). For example, while an irregular object can be weighed, the weight of the object may not be easily obtained because the irregular object is wet and the system needs a dry weight of the irregular object, so a user can specify the weight quality by identifying each object as “light” or “heavy” based on the user's perception. The degree of fitness to size A or B and shape A or B depends on the model and can be adjusted by the user. In some embodiments, the unacceptable group 142D can be a modeled class in the group of classes 140. In some embodiments, the unacceptable group 142D can not be modeled (e.g. because there are too many different features, or measurable data, of the unacceptable irregular objects), and the sorting machine can sort an object into a class (e.g. class one 142A) or sort an object into the unacceptable group 142D. For example, rather than sorting irregular object five 126E into unacceptable group 142D, the system can grade irregular object five 126D into class one 142A because, although it has shape B and size A and class one 142A represents a class with shape A and size A, object five 126E is most like class one 142A out of the remaining classes in the group of classes 140.

For a further example, a training group of diamonds can be fed into the sorting system 130 to generate a model of the diamonds based on measured data such as carat weight, diamond density, and diamond color. Multiple training groups can be used to model the user-specified quality of an acceptable diamond, such as a selection of good diamonds and bad diamonds. A sorting group of diamonds can be fed into the system, and the sorting system 130 can use the model to sort the diamonds into different classes based on the measured data (e.g. class one 142A represents a good diamond based on the measured data of a two carat diamond with a VS1 clarity, and F color, and the sorting system 130 sorts irregular object one 126A into class one 142A because irregular object one 126A is a two carat diamond with VS1 clarity and F color). The end result is each diamond is placed into the appropriate class based on the modeled user-specified qualities and the corresponding measured data. The system and methods described herein can be used with existing sorting machines.

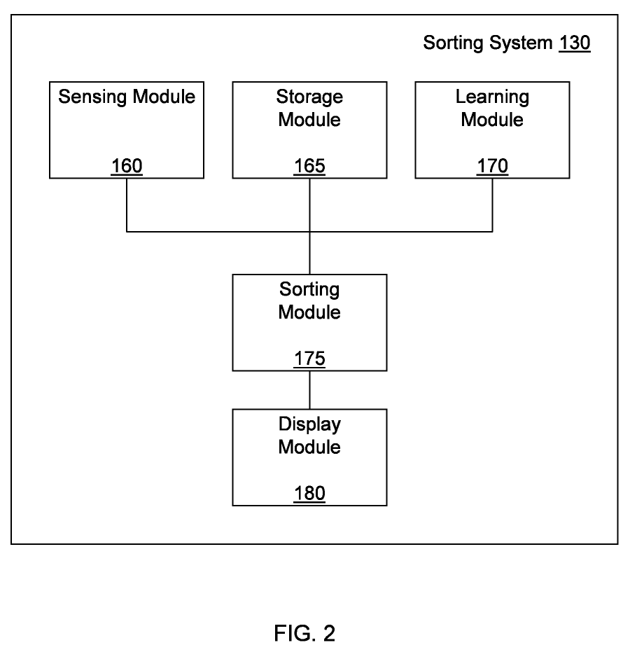

FIG. 2 shows the sorting system 130 of FIG. 1A for sorting irregular objects. The sorting system 130 includes a sensing module 160, a storage module 165, a learning module 170, a sorting module 175, and a display module 180. The sensing module 160 senses features, or measurable data, of the irregular objects. The sensing module 160 uses, for example, machine vision to calculate geometrical features of the irregular objects. The sensing module 160 can use multiple sensors to sense additional features of the irregular objects. The measured features can include length, shape, size, weight, color, thickness, scent, Ph level, molecular composition, density, conductance, texture, spectra, and other features of the irregular object.

The learning module 170 receives the data from the sensing module 160 and generates one or more models for the irregular objects. The models can represent user-specified qualitative decisions and are stored in the storage module 165. The models can be generated, for example, using partial least squares projections to latent structures (PLS), principal components analysis (PCA), or a combination of PCA and PLS. Further details of PCA and PLS analysis can be found in “Multi- and Megavariate Data Analysis, Part I, Basic Principles and Applications”, Eriksson et al, Umetrics Academy, January 2006 and “Multi- and Megavariate Data Analysis, Part II, Advanced Applications and Method Extensions”, Eriksson et al, Umetrics Academy, March 2006 the entirety of which are herein incorporated by reference.

PLS is a multivariate analytical tool commonly used to analyze data. PLS is a method for relating two data matrices, X and Y, to each other by a linear multivariate model. In its simplest form, a linear model specifies the relationship between a dependent or response variable y or a set of response variables Y, and a set of predictor variables X's. For example, the response variable y is a user-specified quality for irregular objects, and the predictor variables X are the measured data for the irregular objects.

A PLS component includes a vector of X-scores t, Y-scores u, weights w and c, and loadings p. PLS components of a PLS model are traditionally calculated using the nonlinear iterative partial least squares (NIPALS) algorithm. There are many variations on the NIPALS algorithm, which consist of a matrix-vector multiplication (e.g., X′y) to generate the weight vector w. The matrix-vector multiplication is computed through a set of vector-vector multiplications xₖ′×y, to result in scalar results Wk.

PLS can be represented graphically. For example, consider a regression application with N observations, 3 X-variables (factors/predictors), and 1 y-variable (response). Here, the dimensions of the X matrix is 3 columns by N observations, and the dimensions of the Y matrix is 1 column by N observations. Because there are two matrices, each row (or each observation of the N observations) corresponds to two points; one point on the X-space for the X matrix and one in the Y-space for the Y matrix. When the data table is graphed for all N observations, there is a cluster of N points in the X-space and a cluster of N points in the Y-space. The first PLS component is a line, or vector, in the X-space which approximates the cluster of points and provides a good correlation with the y-vector. Upon computing the first PLS component, the coordinate of an observation i along the first component vector can be obtained by projecting the sample onto the line to achieve the score tᵢ₁ of observation i. The scores of all the observations form the first X-score vector t₁. A model estimate of y can be determined by multiplying t₁ by the weight of the y-vector c₁:

ŷ₍₁₎=c₁t₁ Equation 1

where:
ŷ₍₁₎ is an estimate of y after one PLS model component;
c₁ is the weight of the y-vector; and
t₁ is the first X-score vector.

Usually, one PLS component is insufficient to adequately model the variation in the y-data. A second PLS component is used to expand on the PLS model. The second PLS component is also a line in the X-space, which passes through the origin and is orthogonal to the first PLS component. After computing the second PLS component, a second score vector t₂ is achieved, as well as weights c₂ and w₂:

ŷ₍₂₎=c₁t₁+c₂t₂ Equation 2

where:
ŷ₍₂₎ is an estimate of y after two PLS model components;
c₁ is the weight of the first y-vector;
t₁ is the first X-score vector;
c₂ is the weight of the second y-vector; and
t₂ is the second X-score vector.

This PLS component generation process is repeated until reaching the desired number of components for the PLS model. Additionally, this can be performed with a single response y or multiple responses Y.

The vector-vector multiplications of the NIPALS algorithm produce similar results to a least squares estimation of a slope of a line through the origin b=(x′y)/(x′x), where x′x is a constant. Further, partial averages of the sorted data set divided into three portions gives a good estimate of b=(yy₃−yy₁)/(xx₃−xx₁), where the average of the highest third of y is yy₃, the average of the lowest third of y is yy₁, the average of the highest third of x is xx₃, and the average of the lowest third of x is xx₁. While partial averages can be a good estimate of b, partial averages can be affected by outside tails of the distribution. Further, computation of PLS components is limited based on the amount of memory available in the processing system. With large amounts of data storage becoming available at lower prices, the size of data sets are becoming increasingly larger than the computer memory available in the processing system. Consequently PLS processing of large data sets becomes time consuming. Further, standard PLS deflates both the X and Y matrices to speed up the computation with constant vector subtractions.

PCA is a multivariate projection method designed to extract and display the systematic variation in a data matrix X, revealing groups of observations, trends, and outliers. Data matrix X is a matrix of data with N rows (observations) and K columns (variables). The observations can be, for example, analytical samples, chemical compounds or reactions, process time points of a continuous process, batches from a batch process, biological individuals, trials of a DOE-protocol, and other measurements. To characterize the properties of the observations, variables are measured. The variables can be, for example, of spectral origin, of chromatographic origin, or measurements from sensors in a process (e.g., temperatures, flows, pressures, curves, etc.).

In some embodiments, the data are pre-processed (e.g., through scaling and mean-centering, described in further detail below). Once pre-processed (if at all), the first principal component (PC1) is computed, which is the line in the K-dimensional space that best approximates the data in the least squares sense. The line goes through the average point, and each observation can be projected onto the line to calculate the observation's score. The model can be extended with additional principal components. Usually, one principal component is insufficient to model the systematic variation of a data set. The second principal component, for example, is also represented by a line in the K-dimensional space which is orthogonal to the first PC. The line also passes through the average point, and improves the approximation of the X-data as much as possible.

To determine which variables are responsible for the patterns seen among the observations, the principal component loadings are analyzed, which are vectors called p₁ and p₂. Geometrically, the principal component loadings express the orientation of the model plane in the K-dimensional variable space. The direction of PC1 in relation to the original variables is given by the cosine of the angles for each variable. For example, for three variables, the direction is given by a₁, a₂, and a₃. These values indicate how the original variables (e.g., x₁, x₂, and x₃ for a three variable matrix) load, or contribute to, PC1. A second set of loading coefficients expresses the direction of PC2 in relation to the original variables.

By using PCA a data table X is modeled as:

X=1* x̅′+T*P′+E Equation 3

where:
1* x̅′ represents the variable averages after pre-processing the data, if any;
T*P′ models the structure; and
E contains noise.

The principal component scores are the columns of the score matrix T (e.g., t₁, t₂, and t₃ for first, second, and third components). These scores are the coordinates of the observations in the model. The scores can be sorted in descending importance (e.g., t₁ explains more variation than t₂). As discussed above, the meaning of the scores is given by the loadings, which build up the loading matrix P (e.g., loadings of the first, second, and third components are p₁, p₂, and p₃. The loadings demonstrate the magnitude (e.g., large or small correlation) and the manner (e.g., positive or negative correlation) in which the measured variables contribute to the scores.

In some embodiments, the data matrices are preprocessed before performing PCA and/or PLS. For example, when using PLS, one or more of the matrices (e.g., matrix X and/or matrix Y) are transformed, centered, and/or scaled by a preprocessing method. Similarly, prior to PCA, the data can be pre-treated into a form suitable for analysis (e.g., to reshape the data such that important assumptions are better fulfilled). PLS modeling works best when the data are generally symmetrically distributed and have a generally constant error variance. Variables that vary more than ten-fold can be logarithmically transformed before the analysis to remove undesired behavior. Transforming variables can improve the predictive power and interpretability of a multivariate model. For example, a dataset which includes measurements that are outliers may unduly influence model building. Manipulating such measurements in some way prior to data analysis prevents the measurements from exerting a large influence on the model, causing the measurements to dominate over the other measurements. For example, outliers can be removed to minimize the effect that the measurements would have on the model.

To give variables (i.e., columns) of a matrix relatively or approximately equal weight in the subsequent analysis, the data can be column-wise transformed, scaled, and/or centered. Transformations of variables are often used to give them a more symmetrical distribution. For example, logarithmic transformations, negative logarithm scaling, logit scaling, square root scaling, fourth root scaling, inverse scaling, or power transformation scaling can be used.

For many types of data, centering and scaling are intertwined. Centering corresponds to a subtraction of a reference vector, where scaling the variables involves multiplying the variables by a scaling vector. The choice of scaling vector is crucial. In situations where variables of different origin and numerical range are encountered the scaling vector is usually chosen as the inverse spread of the variables. In other situations, such as with process data, the scaling vector may be defined relative to a tolerable spread in the variables.

A scaling vector is a representation of a number of observations on a line such that the positioning of the points is related in some mathematical sense to one or more criteria relevant to the observations. The scaling process involves regulating the length of a coordinate axis in variable space according to a predetermined criteria (e.g., that the length of each coordinate axis be set to the same variance). A common technique for scaling data are referred to as “unit variance,” “UV” scaling, or “auto-scaling.” Unit variance scaling involves calculating a standard deviation for a particular variable from a data set. A scaling weight is calculated as the inverse of the standard deviation. Each value of the variable is multiplied by the scaling weight to determine the scaled variable. After all of the variables in the data matrices have been scaled, each of the variables (i.e., coordinate axes) have unit variance.

For example, a user (e.g., a computer or a person) can specify a set of scaling parameters to apply to the data prior to submitting the data to PCA and/or PLS. A scaling file is used to specify particular values of the scaling parameters that are to be used. Scaling is sometimes referred to as pre-treatment or preprocessing of data, before the data are used for subsequent processing or model generation. The measured values of the observations and variables in the data matrices often have substantially different numerical ranges, which results in a large statistical variance in the data. PLS is generally considered a maximum co-variance projection method, where PCA is a maximum variance projection method. As a result, variables or data with a large variance influence the PCA and/or PLS data models more than a variable with a relatively low variance. When variables with a relatively large variance are plotted along a first axis (e.g., plotted along the x-axis, since there is only a single variable) against a variable with a relatively small variance plotted along a second axis (e.g., plotted along the y-axis) with the same scale, the spread in the large-variance variable may dominate the spread in the small-variance variable. As a remedy, the data (and the axes) of both variables can be scaled. The scaling allows variables (i.e., the variable with a relatively large variance and the variable with a relatively small variance) to generally contribute equally to the particular data model. For example, if variable one varies between 0.2 and 1.0 and variable two varies between 17,000 and 30,000, variable two will dominate over variable one unless the data are scaled.

In some embodiments, the user may want to deemphasize particular variables (e.g., noisy variables or irrelevant variables) or increase the contribution of certain variables to the model being created. If a priori knowledge about the relative importance of variables (X for PCA and X or Y for PLS) is available, the knowledge can be used to scale the variables to give important variables higher scaling weight in the model than would otherwise be given to the important variables if unit variance scaling was applied to all the variables. Unimportant variables can be given a lower scaling weight to deemphasize those variables in the model. For PLS, this makes it possible to focus on both important predictor matrix entries and important response matrix entries (or variables) in the model. The user can modify the scaling weights, and thus the variances, to achieve this objective for a particular data set.

Centering variables in a data vector involves subtracting a reference value from each variable in the data vector. In some embodiments, the reference vector has the same dimensions as the data vector (often represented by the mean values of the variables or the settings of the set point). Data in the matrices can be centered about a point other than the origin of the scaled coordinate system. For example, set-point centering can be used as an alternative to mean-centering. Set-point centering allows the process operator to focus on the variability around the set point and not around the average point. When this occurs, a centering value is added to or subtracted from each of the matrix elements as necessary to center the matrix elements about the origin. Both centering and scaling can facilitate interpreting a graph (e.g., a PLS graph) and/or performing the analysis of the data (e.g., PCA and/or PLS). For PLS, when the data in the predictor and response matrices has been pre-processed (e.g., imported and/or centered, transformed, or scaled), a PLS algorithm is applied to the data. For PCA, when the data in matrix X has been pre-processed, a PCA algorithm is applied to matrix X.

The sensing module 160 senses features (i.e., measurable data) of a training group of irregular objects (e.g. the training group 120 of FIG. 1A). The learning module 170 generates models of the training group of irregular objects, and the models are stored in the storage module 165. The sorting module 175 receives data from the sensing module 160. The sorting module 175 sorts the irregular object using the models stored in the storage module 165. The sorting module displays the sorting result to the user using the display module 180. The display module can output a graphical representation of the sorting models as applied to the data of the irregular object. For example, the sensing module 160 senses features of an irregular object from a sorting group of irregular objects (e.g. irregular object one 126 from the sorting group 125 of FIG. 1A). The sorting module 175 receives the data from the sensing module 160 and classifies the irregular object according to a user-specified quality using models stored in the storage module 165 (e.g. models generated by the learning module 170). The result of the classification is displayed to the user using the display module 180.

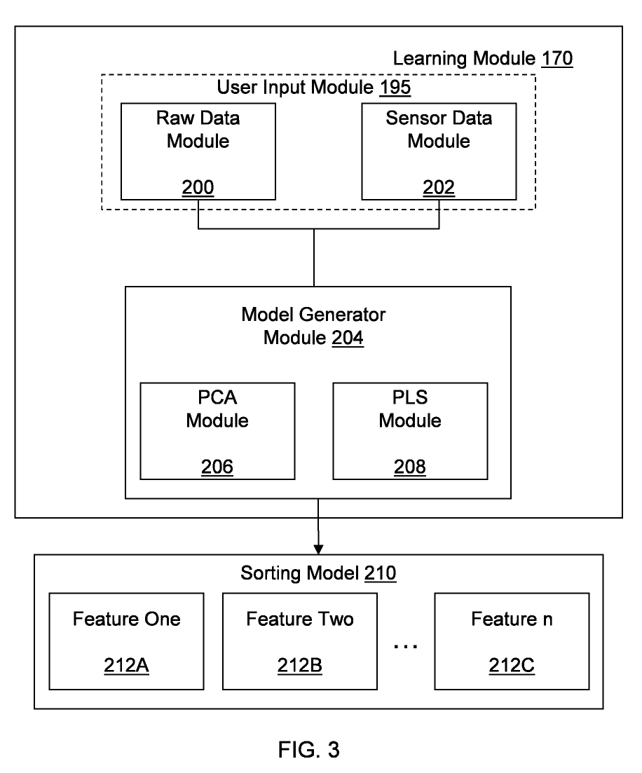

FIG. 3 shows a learning module 170 of FIG. 2 for generating models of irregular objects. The learning module 170 includes a user input module 195 and a model generator module 204. The user input module 195 includes a raw data module 200 and a sensor data module 202. The model generator module 204 includes a PCA module 206 and a PLS module 208. The model generator module 204 generates a sorting model 210. The sorting model 210 includes feature one 212A, feature two 212B, and feature n 212C. The user input module 195 receives data related to the irregular objects (e.g. the training group of irregular objects 120). The data can be used by the model generator module 204 to generate one or more sorting models 210. For example, a user can input a group of acceptable irregular objects, the irregular objects belonging to a class for a user-specified quality to model for the irregular objects. The model generator module 204 can use the group of acceptable irregular objects to generate a sorting model 210 by measuring data of the group of acceptable irregular objects. Sorting can be performed on subsequent irregular objects (e.g. by the sorting module 175) using the generated sorting model 210.

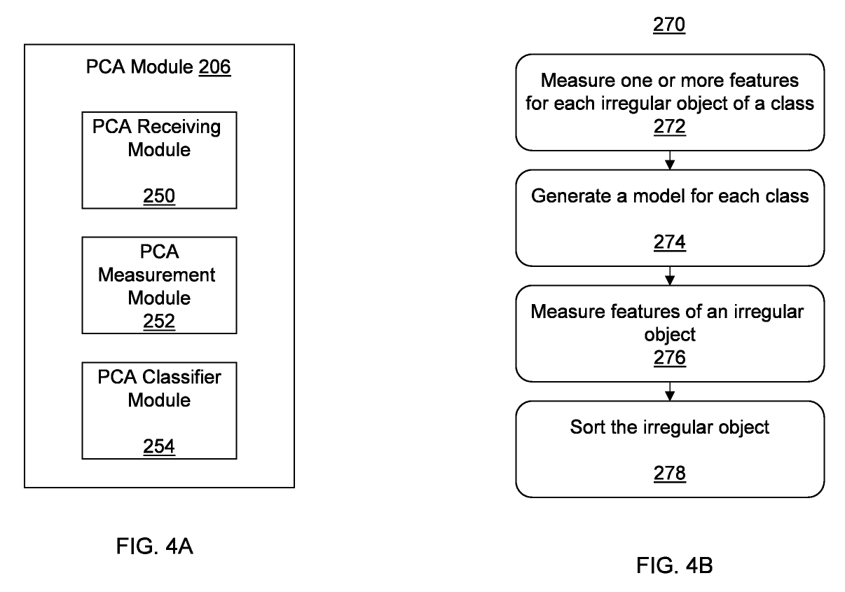

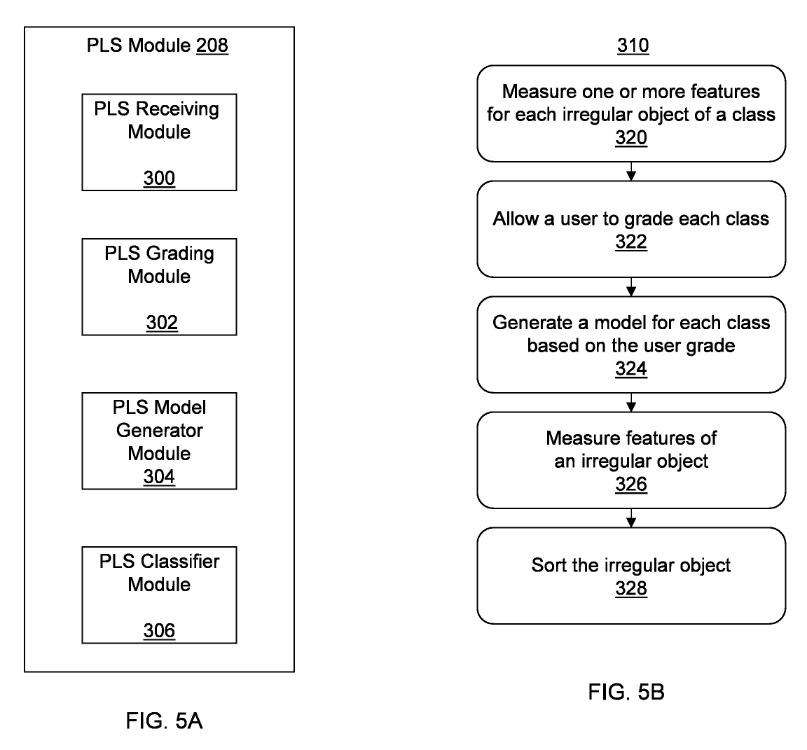

The raw data module 200 and the sensor data module 202 receive and/or measure data for irregular objects. The raw data module 200 receives raw data from the sensing module 160. The raw data can be, for example, pixel vision data for an irregular object. The sensor data module 202 receives sensor data from the sensing module 160. The sensor data can be, for example, calculated geometrical features of an irregular object. The sensor data module 202 can receive additional information from a user. The model generator module 204 generates one or more models of the irregular objects (e.g. sorting model 210) using raw data from the raw data module 200, sensor data from the sensor data module 202, or any combination of these data and any additional data of the irregular objects. The PCA module 206 uses PCA to build PCA models (e.g. sorting model 210) with the data (see FIGS. 4A and 4B). The PLS module 208 uses PLS to build PLS models (e.g. sorting model 210) with the data (see FIGS. 5A and 5B). A user can, for example, remove outliers based on DModX to produce cleaner data for a PCA or PLS analysis. The models can be stored in the storage module 165.

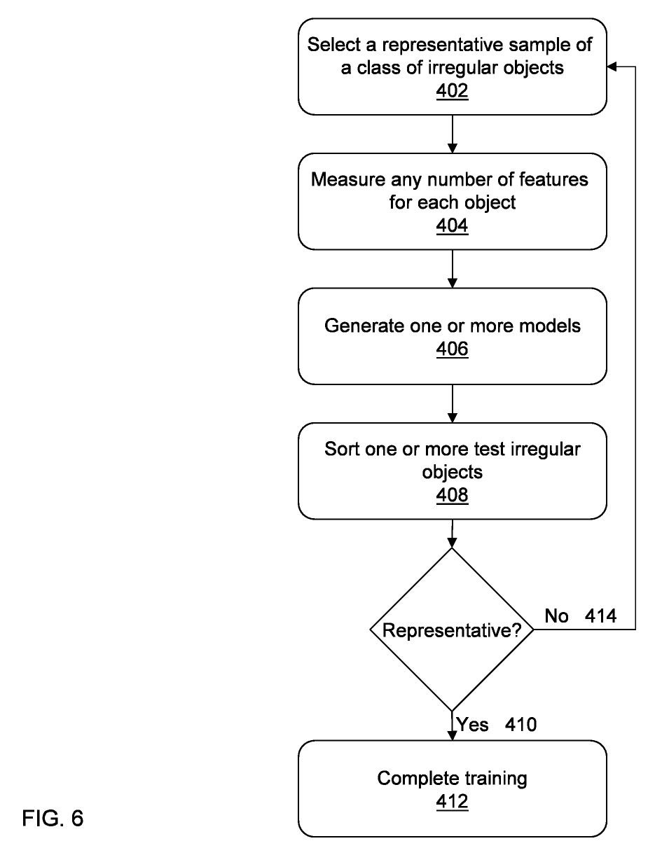

The sorting model 210 can include models for representing user-specified qualities based on any number of features of the irregular objects (e.g. feature one 212A through feature n 212C). For example, features used to sort the irregular objects can include size, shape, color, scent, weight, or any combination of these features or any other pertinent, measurable feature of the irregular objects. The model generator module 204 can create multiple models for various user-specified qualities using different combinations of these features. A user can train the system (See FIG. 6) to adapt the models to accurately represent an objective classification of a qualitative human judgment. The sorting system 130 can, for example, use a combination of two or more models to sort an irregular object (See FIG. 5B) to represent a qualitative judgment.

The user can, for example, input multiple groups of irregular objects, each group of irregular objects belonging to a different class of the irregular objects (e.g. small roses, medium roses, and large roses). The model generator module 204 can use the multiple groups of acceptable irregular objects to generate a sorting model 210 for each group. Sorting can be performed on subsequent irregular objects (e.g. by the sorting module 175) using the generated sorting models 210 to sort the irregular objects into a particular class. The user can input a group of non-acceptable objects. The model generator module 204 can generate a model for the non-acceptable objects, and subsequent irregular objects can be classified as non-acceptable (e.g. by the sorting module 175). In some examples, sorting results can be used to adjust the sorting model 210. For example, percentages can be calculated based on the successful classification of the irregular objects within appropriate classes to determine if the sorting model is working properly.

In some embodiments, only one class of the irregular objects can be mapped. The irregular objects do not form a homogenous class, but consist of objects being non-acceptable for a number of different reasons (e.g. too large, too small, too wide, too narrow, too green, too yellow, etc.). Thus, unacceptable irregular objects do not form a homogeneous class, so a training group of irregular objects cannot be used to model an unacceptable irregular object class. A user can input a group of acceptable irregular objects, the irregular objects belonging to the one class which can be modeled. The model generator module 204 can use the group of acceptable irregular objects to generate a sorting model 210 of acceptable objects based on measured data for the irregular objects. Sorting can be performed on subsequent irregular objects (e.g. by the sorting module 175) using the generated sorting model 210. If the irregular object is not sorted into the modeled class, the unacceptable irregular object is classified as unacceptable. If the irregular object is sorted into the modeled class, the irregular object is classified as acceptable.

FIG. 4A shows the PCA module 206 from FIG. 3 for performing PCA analysis on the irregular objects. The PCA module 206 includes a PCA receiving module 250, a PCA measurement module 252, and a PCA classifier module 254. The PCA receiving module 250 receives data for PCA analysis. For example, the PCA receiving module 250 receives data from the raw data module 200 and sensor data module 202. For example, the PCA receiving module 250 receives data for a group of objects belonging to one or more classes of the irregular objects, and the system can sort the irregular objects (e.g. by the sorting module 175). The PCA measurement module 252 uses cross-validation (CV) to determine the number of significant components. The PCA measurement module 252 generates models of the irregular objects. The PCA classifier module 254 uses the models to select a class of the irregular objects which has the best fit. The results show groups, trends, outliers, and other expected or unexpected regularities of the irregular objects. A user can, for example, remove outliers to produce a cleaner data set for PCA or PLS analysis.

FIG. 4B shows the PCA sorting process 270 for sorting irregular objects using PCA. Two or more features are measured (272) for each irregular object of a class. If, for example, a user inputs multiple groups of irregular objects, where each group is related to a particular class of a user-specified quality of the irregular objects (e.g. small petals, medium petals, and large petals), each class will generate a PCA model (e.g. via the sorting model 210) based on the measured data. The class can be, for example, previously sorted by a user. A model (e.g. the sorting model 210 of FIG. 3) is generated (274) for each class (e.g. by the PCA measurement module 252). The model 210 or models can be stored in the storage module 165. To sort an irregular object, features of the irregular object are measured 276. Additional sensory information can be utilized for the irregular object. The irregular object is sorted (278) based on the generated sorting models 210. For example, T2 and DModX are computed for each model 210, and the class with the best result is chosen to contain the irregular object.

If, for example, multiple PCA models (e.g. sorting models 210) are generated for a type of irregular object, the sorting model 210 can select the best membership of the irregular object within a particular class. For example, if several training groups are provided to the system, each training group belonging to a different class, the system generates a PCA model for each class. The PCA sorting process 270 can include error checking (e.g. in the PCA classifier module 254). For example, if the wrong type of irregular object is fed into the sorting system 130, the PCA classifier module 254 can compute the distance of the irregular object to the model, DModX. If DModX is too great (e.g., larger than a critical distance calculated from the training set) the PCA classifier module 254 can identify the irregular object as an outlier.

FIG. 5A shows the PLS module 208 from FIG. 3 for performing PLS analysis on the irregular objects. The PLS module 208 includes a PLS receiving module 300, a PLS grading module 302, a PLS model generator module 304, and a PLS classifier module 306. The PLS receiving module 300 receives data for PLS analysis. For example, a user can provide a perceived quality (i.e. the Y or Y's of the response matrix of the PLS model). The PLS receiving module 300 can, for example, receive measured data from the raw data module 200 and sensor data module 202. The PLS grading module 302 allows a user to grade each class of irregular objects. Each class may have multiple qualifications. Each grade can be Y for the PLS model. A user can, for example, inspect the results and remove outliers to produce cleaner data for further PLS analysis. The PLS model generator module 304 produces a model of the relationship of all X-variables of one matrix related to one of the other matrices (with Y-variables) resulting in a relationship model that shows which Y-variables are related to which X-variables, the strength of the associations, and the correlations between the X's and Y's. CV can be used to determine the number of significant components in the model. The PLS classifier module 306 sorts irregular objects using the PLS models generated by the PLS model generator module 304. The classifier module 306 can, for example, compute the Y's and use simple parameter sorting based on these computed Y's as long as DModX is below a critical level.

FIG. 5B shows the PLS sorting process 310 for sorting irregular objects using PLS analysis. Two or more features are measured (320) for each irregular object of a class. The irregular objects can be previously sorted by a user of the system. A user grades (322) each class (e.g. using the PLS grading module 302). The user may use multiple qualifications to grade each class. One or more PLS models (e.g. the sorting model 210 of FIG. 3) are generated (324) for each class with one or more Y's (e.g. using the PLS model generator model), where the Y's are determined in step 322 and are the user-specified qualities, while the X's are the measured data. The system (e.g. the sorting system 130 of FIG. 1A) can, for example, grade the irregular objects by predicting the Y or Y's of the PLS model based on measured data for the irregular objects. The model 210 or models can be stored in the storage module 165. Features of an irregular object to sort based on the PLS models 210 are measured 326. The irregular object is sorted (328) based on the features (i.e. measured data) using the PLS models (e.g. using the PLS classifier module 306). The irregular object is sorted, for example, by computing the Y's and using simple parameter sorting with these Y's as long as DModX is below a critical level. Advantageously, using PLS can reduce a high number of qualities into a manageable number of qualities.

The PCA sorting process 270 and the PLS sorting process 310 can be used in combination. For example, the PCA sorting process 270 can validate and ensure “membership” of the irregular object within a particular class, and the PLS sorting process 310 can predict user-specified qualities (i.e., Y's) based on measured data (i.e., X's) and perform the actual sorting of the irregular object (e.g., sort the irregular objects within the particular class determined with PCA sorting process 270). The order of the sorting processes remains independent, and PLS sorting can be performed before PCA sorting. For example, the PCA sorting process 270 can group roses into three classes of small roses, medium roses, and large roses. A user can provide a group of irregular objects, the training group of irregular objects 120, to generate a model of a class for the irregular objects (see FIGS. 4A and 4B), and can provide at least one perceived quality (see FIGS. 5A and 5B), and the system (e.g. the sorting system 130) can calculate membership and grade for an irregular object. The PLS sorting process 310 can sort the small roses into good quality small roses, medium quality small roses, and poor quality small roses. This can be performed for each PCA class. An expert in the field can appreciate how other sorting methods can be used in combination with the previously mentioned sorting methods.

FIG. 6 shows the learning process 400 for learning user-specified quality sorting criteria for irregular objects. A representative sample of a class of irregular objects are selected 402. Any number of data measurements (e.g., features) associated with a corresponding user-specified quality are measured individually for an irregular object within the representative sample 404. For example, the size and shape of the irregular object can be modeled based on measured data. One or more models are generated for the irregular object 406. For example, a model can be generated for a small rose with a particular shape A of the flower. The model can incorporate any number of parameters (i.e., measured data) to define the sorting criteria (e.g., size and shape). One or more sample irregular objects are sorted 408 to determine whether or not the one or more models generated are representative of the subjective classification to use with the sorting system (e.g. the sorting system 130). If the one or more models are representative of the desired classification 410 the training is completed 412. If the sorting fails to sort irregular objects correctly 414, the process returns to step 402 and a new representative sample of irregular objects is chosen by the user. The user can, for example, grade the Y values of the PLS models to achieve the desired subjective classification.

With reference to the above described systems and methods, in some implementations of the invention, a human evaluator inputs (e.g., to the user input module 195 of the learning module 170 of FIG. 3) user-specified qualities related to a set of irregular objects. These data can be related to subjective qualities of the irregular objects (e.g., data which can not normally be measured). For example, to model the size of flowers, since it is difficult to classify what constitutes a “bigger” flower, the user can input user-specified qualities to classify flowers as small, medium, or large. Similarly, for the shape of the flowers, the user can input user-specified qualities to indicate a good shape or a poor shape. The sorting system 130 measures data for the first set of irregular objects (e.g., via sensing module 160 of FIG. 2) to allow the sorting system 130 to associate measurable characteristics of the irregular objects with the user input characteristics. The measured data are one or more objective qualities (i.e., qualities that can be easily measured). For example, the size of the flowers (i.e., user-specified quality) may be related to certain objective, easily measurable characteristics of the flower, such as stem length, stem thickness, flower shadow (e.g., the number of black pixels in a black-and-white representation of the flower), or a bounding rectangle about the flower. The shape of the flower (i.e., user-specified quality) may be related to the volume of the flower, the number of petals, the length of the petals, or the color of the flower (i.e., measured data). In some examples, the system begins by using twenty to thirty data measurements of the irregular objects for a particular user-specified quality. In some embodiments the system reduces the number of dimensions as the model training progresses using generally known principles associated with, for example, PLS or PCA analysis.

In some embodiments, in addition to basic data measurements of the irregular objects, the sorting system 130 uses more detailed (i.e., sophisticated) data measurements. For example, for a flower, the sorting system 130 can look at an image of the foliage to determine measurable data for the flower head. As another example, the system can count the number of berries in a bunch while excluding any leaves in the bunch. The number of berries would be used as a data measurement.

The sorting system 130 generates one or more PCA models, one or more PLS models, or a combination of both models (e.g., via model generator module 204 of the learning module 170 of FIG. 3) based on the user measured data and the user-specified qualities. The sorting system 130 can generate any number and any combination of PCA and/or PLS models (e.g., just one PCA model, just one PLS model, a PCA and a PLS model, multiple PCA models, multiple PLS models, or a combination of PCA and PLS models). The one or more PCA or PLS models links measured data of the irregular objects with user-specified qualities. The generated models can be used to sort and/or grade additional sets of irregular objects into user-specified qualities. The sorting system 130 measures the same measured data for each member of the second set of the irregular objects, and sorts (e.g., with the sorting module 175) the members of the second set of irregular objects using the one or more PCA or PLS models and the measured data for the second set of irregular objects. For example, new flowers can be sorted/graded by measuring the above mentioned measured data and using the models to associate a user-specified quality with the flowers. Advantageously, a system (e.g., the sorting system 130) can be trained to classify irregular objects based on user-specified qualities, such as a “pretty” flower or a “large” flower.

The one or more PCA or PLS models can be used to grade irregular objects rather than defining all the possible classes for a particular user defined input of irregular objects. For example, assume a user trains a model to use certain measured data of flowers to classify the size of flowers as either a “small” flower, a “medium” flower, or a “large” flower (i.e., user-specified qualities). Although the model does not define a “small-medium” flower class, the model can still be used to measure a “small-medium” flower by determining whether the “small-medium” flower is more like the “small” flower class or the “medium” flower class. Advantageously, this mirrors human perceptions of the “small-medium” flower. Instead of rejecting the flower as neither “small,” “medium,” or “large,” the system grades the flower into the class it most closely resembles based on its associated measured data (e.g., if the “small-medium” flower is more like the “small” class rather than the “medium” class, the system associates the “small-medium” flower with the “small” class). Advantageously, rather than trying to classify objects and/or predict a well-defined characteristic, the objects can be graded to model user-specified qualities, which are not easily measured. For example, the sorting system can be used to sort flowers into groups which achieve a maximum profit. While a bunch of small flowers has a relatively low value and a bunch of large flowers has a higher market value, the sorting system can be trained to grade bunches of small and large flowers into classes in a way so as to maximize the profitability of the flower groupings (e.g., three large flowers and two small flowers provides the highest average cost per bunch, which is the maximum profit group for flowers).

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

While this invention has been particularly shown and described with references to preferred embodiments thereof, it will be understood by those skilled in the art that various changes in form and details may be made therein without departing from the scope of the invention encompassed by the appended claims.

What is claimed is:

1. A computerized method of sorting irregular objects, comprising:
receiving a representative set of irregular objects comprising at least two types of user-specified qualities;
receiving at least two types of measured data for the representative set of irregular objects;
generating at least one of a PCA model or a PLS model based on the at least two user-specified qualities of the irregular objects and the at least two types of measured data for the representative set of irregular objects; and
sorting a second set of irregular objects based on the at least one of the PCA model or the PLS model.

2. The method of claim 1, wherein the representative set of irregular objects comprise a class of the irregular objects.

3. The method of claim 1, wherein generating at least one of a PCA model or a PLS model comprises generating at least one PCA model and at least one PLS model based on the at least two user-specified qualities of the irregular objects and the at least two types of measured data for the representative set of irregular objects.

4. The method of claim 3, further comprising sorting the second set of irregular objects based on the at least one PCA model and the at least one PLS model.

5. The method of claim 1, wherein sorting comprises:
calculating membership of the second set of irregular objects within a class; and
sorting the second set of irregular objects within the class.

6. The method of claim 5, wherein calculating membership comprises:
computing T2 and DModX for the PCA model; and
selecting a class of the second set of irregular objects based on T2 and DModX.

7. The method of claim 1, wherein sorting comprises sorting the second set of irregular objects within a class.

8. The method of claim 7, sorting the second set of irregular objects comprises computing a grade of the second set of irregular objects and sorting the irregular objects based on the grade.

9. The method of claim 8, wherein computing a grade of the second set of irregular objects is based on a user input.

10. The method of claim 7, wherein sorting the second set of irregular objects comprises parameter sorting.

11. The method of claim 1, further comprising calculating a maximum profit group of the second set of irregular objects.

12. The method of claim 1, further comprising adjusting the at least two user-specified qualities of the irregular objects based on a user-specified qualitative perception of the irregular objects.

13. The method of claim 1, wherein the irregular objects comprises plants, flowers, insects, vegetables, fruits, leaves, trees, or any combination thereof.

14. The method of claim 1, wherein the at least two user-specified qualities comprises length, shape, size, weight, color, thickness, scent or any combination thereof.

15. The method of claim 14, wherein the at least two user-specified qualities are based on a particular feature of the irregular objects.

16. The method of claim 1, further comprising generating the PCA model by specifying the at least two user-specified qualities for a specimen of a class and building a model for the class.

17. The method of claim 16, further comprising previously sorting the specimen.

18. The method of claim 1, further comprising generating a PLS model by specifying the at least two user-specified qualities for a specimen of a class, grading the class, and building a model for the class.

19. A system for sorting irregular objects, comprising:
a learning module configured to generate at least one of a PCA model or a PLS model based on at least two user-specified qualities of the irregular objects received for a representative set of the irregular objects and at least two types of measured data for the representative set of the irregular objects; and
a sorting module configured to sort a second set of irregular objects based on the at least one of the PCA model or the PLS model.

20. The system of claim 19, wherein the learning module is further configured to generate at least one PCA model and at least one PLS model based on the at least two user-specified qualities of the irregular objects and the at least two types of measured data for the representative set of irregular objects.

21. The system of claim 20, wherein the sorting module is further configured to sort the second set of irregular objects based on the at least one PCA model and the at least one PLS model.

22. The system of claim 19, wherein the learning module is further configured to generate a PCA model based on a user specifying the at least two qualities for a specimen of a class and building a model for the class.

23. The system of claim 19, wherein the learning module is further configured to generate a PLS model based on measuring the at least two user-specified qualities for a specimen of a class, grading the class, and building a model for the class.

24. The system of claim 19, further comprising a sensing module configured to sense one or more characteristics of the representative set of irregular objects.

25. The system of claim 19, further comprising a storage module configured to store the at least one of a PCA model or a PLS model.

26. A computer program product for sorting irregular objects, tangibly embodied in an information carrier, the computer program product including instructions being operable to cause a data processing apparatus to:
receive a representative set of irregular objects comprising at least two types of user-specified qualities;
receive at least two types of measured data for the representative set of irregular objects;
generate at least one of a PCA model or a PLS model based on the at least two user-specified qualities of the representative set of irregular objects and the at least two types of measured data for the representative set of irregular objects; and
sort a second set of irregular objects based on the at least one of the PCA model or the PLS model.

27. A computerized method for sorting irregular objects, comprising:
receiving a representative set of irregular objects comprising at least two types of user-specified qualities;
receiving at least two types of measured data for the representative set of irregular objects;
means for generating at least one of a PCA model or a PLS model based on the at least two user-specified qualities of the irregular objects and the at least two types of measured data for the representative set of irregular objects; and
means for sorting the second set of irregular objects based on the at least one of the PCA model or the PLS model.
